(19) United States
(12) Patent Application Publication
(10) Pub. No.: US 2008/0280035 A1
(43) Pub. Date: Nov. 13, 2008

(54) IN-LINE METHOD TO REFURBISH FUSER MEMBERS

(76) Inventors: Shyh-Hua E. Jao, Pittsford, NY (US); Jiann-Hsing Chen, Fairport, NY (US); Muhammed Aslam, Rochester, NY (US); Joseph A. Pavlisko, Pittsford, NY (US); James H. Hurst, Rochester, NY (US)

Correspondence Address: Andrew J. Anderson;Patent Legal Staff, Eastman Kodak Company, 343 State Street, Rochester, NY, 14650-2201, US

(21) Appl. No.: 11/746,083

(22) Filed: May 9, 2007

(51) Int. Cl. B32B 43/00

(52) U.S. Cl. 427/140

(57) ABSTRACT

The present invention provides a method of resurfacing a fuser member in-situ. The method includes providing a fuser member having an outer surface of a high temperature fluorothermoplastic. When it is determined that the outer surface is in need of resurfacing, the fuser member is rotated at a speed of at least 1 rpm while engaging the outer surface of the fuser member with at least one heating roller at a pressure of at least 5 psi at a temperature of at least 10° C. below the fluorothermoplastic melting temperature for a time sufficient to resurface of the outer surface of the fuser member.

### CROSS-REFERENCE TO RELATED APPLICATIONS

This application relates to commonly assigned, copending application U.S. application Ser. No. ______ (Doc. # 93412) “ELETROPHOTOGRAPIC MACHINE” filed simultaneously herewith.

### FIELD OF THE INVENTION

This invention relates to electrostatographic apparatus and fuser members and methods for refurbishing coated fuser members, and in particular to a fuser roller or member which is coated with an outermost fluoropolymer resin layer.

### BACKGROUND OF THE INVENTION

The surface (or the topcoat) for fuser members in oil-less fusing requires ultra low surface energy to release the substrate. An improved topcoat material oil-less fusing is high-temperature tolerant thermoplastic, such as, FEP, PFA or PTFE, described in U.S. Ser. Nos. 11/472,918, 11/472,771, 11/472,888 and 11/472,919.

However, during fuser printing performance tests paper edges, particularly of thick paper, can occasionally leave wear marks on the topcoat of the fuser surface. These paper edge marks can show up on wider paper as gloss-variation artifacts when subsequent prints are made on a substrate covering the worn area. Moreover, for printing special images, particularly one with in-track stripes of area of no toners, foreign materials from paper are seen to periodically accumulate on the surface of the topcoat due to the absence of toners, leading to artifacts, such as gloss variation band artifact occurring when printing a different image content subsequently as a full page image. Typically, when such image defects occur, the fuser member or members are replaced.

The present invention eliminates this procedure of replacing fuser member due to the aforementioned artifacts by providing a method for refurbishing fuser members in-situ.

The practice of the proposed refurbishing scheme and the accessory surface cleaning scheme depends on the severity of the artifact present on the fuser surface, which in turn is a function of the service history of fuser members.

### SUMMARY OF THE INVENTION

The present invention provides a method of resurfacing a fuser member in-situ. The method includes providing a fuser member having an outer surface of a high temperature fluorothermoplastic. When it is determined that the outer surface is in need of resurfacing, the fuser member is rotated at a speed of at least 1 rpm while engaging the outer surface of the fuser member with at least one heating roller at a pressure of at least 5 psi at a temperature of at least 10° C. below the fluorothermoplastic melting temperature for a time sufficient to resurface of the outer surface of the fuser member.

### BRIEF DESCRIPTION OF THE DRAWINGS

FIG. 1 is a cross-sectional view of a fuser member in the printing machine equipped with externally heating device or rollers herein as example suitable for refurbishing in accordance with the present invention.

For a better understanding of the present invention together with other advantages and capabilities thereof, reference is made to the following description and appended claims in connection with the preceding drawings.

### DETAILED DESCRIPTION OF THE INVENTION

The present invention can be applied to refurbishing fuser members with thermoplastic topcoat materials, such as FEP (polyfluorinated ethylene-propylene), PFA (perfluoroalkoxy-tetrafluoroethylene), or PTFE (polytetrafluoroethylene). The instant invention is not dependent on how the fuser member is manufactured, i.e., not affected by whether the topcoat is sleeve molded, sintered with dispersion, sprayed or transfer-coated, etc. The method of the present invention will increase the usable life of the fuser member owing to its ability to restore a uniform gloss surface finish of the fusers in its intended robustness of printing applications across different substrate types.

In all embodiments, fuser members are preferably cylindrically symmetrical, i.e., a cross-section of the roller taken at a right angle to the roller axis anywhere along the length of the member or roller has radial symmetry around the roller axis. The length of the roller thereof determines the range of the printing width of the substrate.

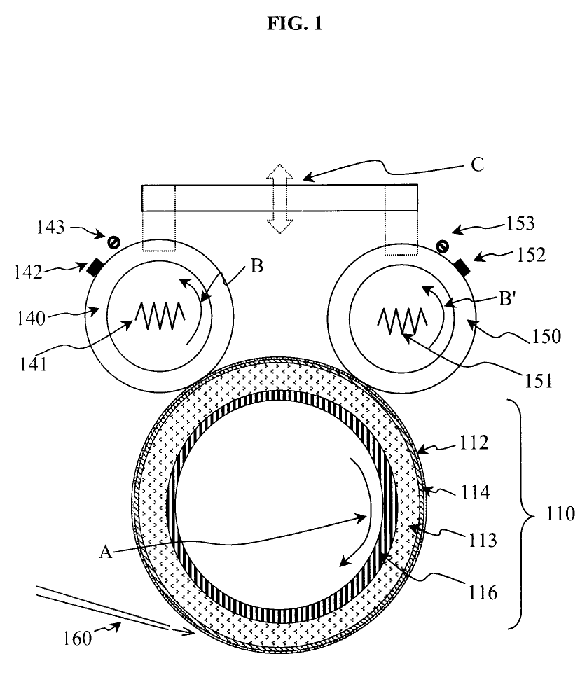

FIG. 1 shows a cross-sectional view of a fuser member 110, suitable for use in the present invention. The generally concentric central core 116 for supporting the plurality of the layers is usually metallic, such as stainless steel, steel, aluminum, etc. The primary requisite for the material for core 116 is that it provides the necessary stiffness, being able to support the force placed upon it and to withstand a possibly higher temperature than the surface of the roller where there is an optional internal heating source. For externally heated fuser members, the internal heat source can be optional, though in most practical cases, the internal heat supply is used in combination with the external heat source to fuse the toners for print quality manipulation. The internal heat source is not shown in the present embodiment of the invention. Various layers can be deposited above the support 116 such as a resilient layer, also termed a cushion layer 113, tie layers, adhesion promotion layers, and primer layers 114 for bonding the cushion layer with the outmost layer 112. The outermost layer 112, is a toner release layer, which includes a thermoplastic fluoropolymer such as PTFE, PFA, and FEP, etc. and blends thereof.

FIG. 1 shows the heater rollers 140, 150 made of rigid materials, such as chromed steel. FIG. 1 also shows the temperature sensors 142, 152, the over-temp device 143, 153 and the heating elements 141, 151 of the heater rollers 140, 150 and a program-controllable loading assembly C to engage the heater rollers with the fuser member used in the normal printing service for fusing system with heating source externally to the fuser member. For this invention, the proximity of the over-temp device to the heater roller surface is adjustable and the temperature sensors are calibrated for temperature range up to around the melting point of the topcoat allowing much higher temperature set points needed for fuser member surface refurbishing than those used in the normal printing. When the fuser member refurbishing program is activated, the proximity of the over-temp sensor is adjusted to be farther away from the heater roller surface to a pre-determined distance in the range of 0.5 mm to 3 mm such that it can serve its function as the fusible safety device for higher than the normal printing temperature set points and both the heater roller engagement, temperature and rotational speed of the fuser member then follow a programmed function which is known to produce best refurbished fuser member surface.

The fuser member can be a pressure or fuser plate, pressure or fuser roller, a fuser belt or any other member on which a release coating is desirable. The support for the fuser member can be a metal element with or without additional layers adhered to the metal element. The metal element can take the shape of a cylindrical core, plate or belt. The metal element can be made of, for example, aluminum, stainless steel or nickel. The surface of the metal element can be rough, but it is not necessary for the surface of the metal element to be rough to achieve good adhesion between the metal element and the layer attached to the metal element. The additional support layers adhered to the metal element consist of layers of materials useful for fuser members, such as, silicone rubbers, and adhesion promoter layer to metal core.

The fluoropolymer resin outer layer includes a fluoropolymer material, such as a semicrystalline fluoropolymer or a semicrystalline fluoropolymer composite. Such materials include polytetrafluoroethylene (PTFE), polyperfluoroalkoxy-tetrafluoroethylene (PFA), polyfluorinated ethylene-propylene (FEP), poly(ethylenetetrafluoroethylene), polyvinylfluoride, polyvinylidene fluoride, poly(ethylene-chloro-trifluoroethylene), polychlorotrifluoroethylene and mixtures of fluoropolymer resins. Some of these fluoropolymer resins are commercially available from DuPont as Teflon™ or Silverstone™ materials.

One embodiment of the invention includes a set of specialized programmed schemes to simultaneously heat and pressurize the thermoplastic topcoat of the fuser member to a temperature at least 10° C. below the melting temperature of the outer surface topcoat material, for example, from 280 to 320° C. for PFA and PTFE materials, and at a pressure of at least 5 psi, i.e. to refurbish the topcoat material, by taking advantage of the heater rollers which are used for externally heated fusing assembly in the printing machine. This set of specialized programmed schemes will automatically control the flow of the following steps at a printing press by the main machine control.

(1) Raise the temperature of the heater roller higher than that for normal printing operation such that the fuser roller surface temperature is brought to at least 10° C. below the melt temperature of the topcoat materials;

(2) Set the fuser roller and the heating roller over-temperature sensors to a pre-determined distance suitable for refurbishing temperature range, other than the normal printing mode set-points;

(3) Rotate the fuser member at a rotational speed at least 1 rpm, engage the heater roller with a contact pressure of at least 5 psi and up to a needed level at least 10° C. below the melt temperature of the topcoat materials;

(4) Turn on the cooling air that cools the fuser member at a position away from the nip of the heater roller to prevent overheating of the sublayers and to have fast recovery to the normal printing mode set-points;

(5) Engage the heater rollers on the fuser member surface with program-controlled functions of pressure and temperature for a period of time sufficient to refurbish the fuser member, typically a range of 1 to 3 minutes.

The present invention preferably is initiated after the fuser member has serviced a same print job for a period of time such that artifact may show up in a subsequent different print job, depending on the printing service requirement. Artifacts that require fuser member refurbishing include, a paper edge wear marks, foreign materials or paper dust from paper in the area of no toner stripes and/or scratch lines due to the fabric cleaning pad applied directly to the fuser roller surface or any other mishap. The initiation of the fuser member refurbishing program can also be a part of the scheduled maintenance.

Before activating the above refurbishing scheme, it is necessary to assure clean surfaces of the fuser member and heater rollers, i.e. the fuser member surface should be free of contamination, such as, residual toner or deposit of foreign materials, such as from paper. A method to clean the surfaces of the fuser member as well as the heater rollers to precede the method of the present invention is done by non-invasive methods such as by applying soft rags with solvents. For fuser members of mild contamination of foreign materials, the cleaning can be also automatically done by printing a few papers with toners covering the full paper, i.e., the toner itself is used to take away foreign materials.

### EXAMPLE

An example is given on a fuser member made of 25-micron-thick PFA (of a melting temperature 305° C.) topcoat, under which is 35-micron-thick Viton, under which is 200-mil-thick silicone rubber. The fuser member serviced for 10,000 A4-equivalent prints of Tabloid sized paper of 300-micron thick on a Nexpress 2100 printing press with external heated fuser assembly and showed de-glossing along the in-track paper edge on the topcoat. The subsequent print on a wider coated paper showed a gloss drop in G60 value by 20 points along the de-glossed edge of the fuser member. The fuser member refurbishing program was activated. The fuser member was refurbished at temperature around 300 to 305° C. of the external heater rollers with a programmed pressure that started from 5 psi and increased to 30 psi for about 2 minutes in line to the extent that the paper edge de-glossing was not visible on the fuser member and the subsequent print on a wider coated paper showed non-measurable difference in G60 value on the print that contacted the Tabloid-sized paper edge area of the fuser member.

The invention has been described in detail with particular reference to certain preferred embodiments thereof, but it will be understood that variations and modifications can be effected within the spirit and scope of the invention.

1. A method of resurfacing a fuser member comprising:
providing a fuser member comprising an outer surface comprising a fluorothermoplastic
engaging the outer surface of the fuser member with at least one heating roller at a pressure of at least 5 psi at a temperature of at least 10° C. below the melt temperature of the fluorothermoplastic;
rotating the fuser member while engaged with the at least one heating roller for a time sufficient to resurface of the outer surface of the fuser member.

2. The method of claim 1 wherein the fluorothermoplastic comprises a fluoropolymer resin selected from the group consisting of polytetrafluoroethylene, polyperfluoroalkoxy-tetrafluoroethylene, polyfluorinated ethylene-propylene, polyvinylfluoride, polyvinylidene fluoride, poly(ethylene-chloro-trifluoroethylene), polychlorotrifluoroethylene and blends thereof

3. The method of claim 1 wherein the fuser roller is rotated at a speed of at least 1 rpm.

4. The method of claim 1 the outer surface of fuser member is cleaned prior to engaging the outer surface of the fuser member with the heating roller.
